(19) United States
(12) Patent Application Publication
(10) Pub. No.: US 2005/0096572 A1
(43) Pub. Date: May 5, 2005

(54) Tri-point replaceable handheld massage device

(76) Inventor: Ming-Tao Hua, Sinjhuang City (TW)

Correspondence Address: Troxell Law Office PLLC, 5205 Leesburg Pike Suite 1404, Falls Church, VA, 22041, US

(21) Appl. No.: 10/697,310

(22) Filed: Oct. 31, 2003

(51) Int. Cl. A61H 7/00

(52) U.S. Cl. 601/135; 601/137

(57) ABSTRACT

A tri-point replaceable handheld massage device includes a main body, massage sections and neck sections. One end of each neck section is joined with each massage section via a dilated section for increasing mechanical strength between the neck sections and the massage sections. The other end of each neck section has a screw thread for screwing and fastening a plurality of neck sections joined with the massage sections into a plurality of screw openings. An end portion of each screw thread has a projecting section for increasing mechanical strength of assembled main body and neck sections to prevent breakage.

### BACKGROUND OF THE INVENTION

a) Field of the Invention

The invention relates to a tri-point handheld massage device. More particularly, to a tri-point handheld massage device having a structure characterized that, each massage section is joined with a neck section with a joined portion of each massage section and each neck portion being a dilated section, and each dilated section is a gradually expanded structure for effectively distributing and absorbing force applied by a user when in use to prevent the neck portions from breakage.

A front end of each neck portion is provided with a screw thread for screwing and fastening the neck sections into a main body. Thus, a user is able to replace massage sections having various sizes according to actual usage needs. An end portion of each neck section has a projecting section for increasing mechanical strength between the assembled main body and neck sections to prevent breakage.

When putting the invention to use, a user is able to replace the massage sections having appropriate sizes required for obtaining optimum massage effects. The main body and the massage sections can be dissembled as desired at all times, thereby offering a user with storage and portability conveniences.

(b) Description of the Prior Art

Referring to FIG. 1, a prior handheld massage device A has a main body A1 provided between massage sections A2 and A3, which are joined with the main body A1 using neck sections A4. However, for being column-shaped in design, the neck sections A4 are likely snapped and damaged from excessive force applied by a user when in use.

In addition, sizes of the massage sections A2 and A3 are invariable, and therefore the massage sections A2 and A3 cannot be replaced according to portions of a user to be massaged. Practical values are lessened as a result.

Moreover, the prior handheld massage device A accomplishes massage purposes using the only two effective massage sections A 2 and A3. Not only effective massage sections are insufficient but also the massage device itself is also hard for a user to hold. The massage device A1 may be frequently fallen off from hands of a user when in use.

Hence, technical contents of the present invention are targeted at overcoming the aforesaid drawbacks.

### SUMMARY OF THE INVENTION

The object of the invention is to provide a tri-point replaceable handheld massage device shown in FIGS. 2, 3 and 4. A handheld massage device B comprises a main body D and a plurality of massage sections C, C1, C2, C3, C4 and C5. The replaceable handheld massage device B is characterized that, each of the massage sections C, C1, C2, C3, C4 and C5 is joined with a neck section E, and a joining portion of each neck section E and each of the massage sections C, C1, C2, C3, C4 and C5 is provided with a dilated section E1. The dilated sections E1 are structures with gradually expanded volumes, so as to prevent the neck sections E from breakage by effectively distributing and absorbing forces applied by a user when the invention is in use.

A front end of each neck section E has a screw thread E2 for screwing and fastening each neck section E into each screw opening B1 at the main body D. Thus, it is made easy that a user replace massage sections C, C1, C2, C3, C4 and C5 according to actual needs. An end portion of each screw thread E2 of each neck section E is devised with a projecting section E3, which reinforces mechanical strength of the main body E and the neck sections E to prevent breakage when the neck sections E are screwed and fastened to the main body E.

With reference to FIG. 2, when the invention is put to use, optimum massage effects are obtained by replacing the massage sections C, C1, C2, C3, C4 and C5 having most suitable sizes according to portions to be massaged. In addition, the massage sections C, C1, C2, C3, C4 and C5 may be dismantled from the main body as desired at all times, thereby facilitating storage and portage of the invention.

### BRIEF DESCRIPTION OF THE DRAWINGS

FIG. 1 shows an elevational view of a prior handheld massage device.

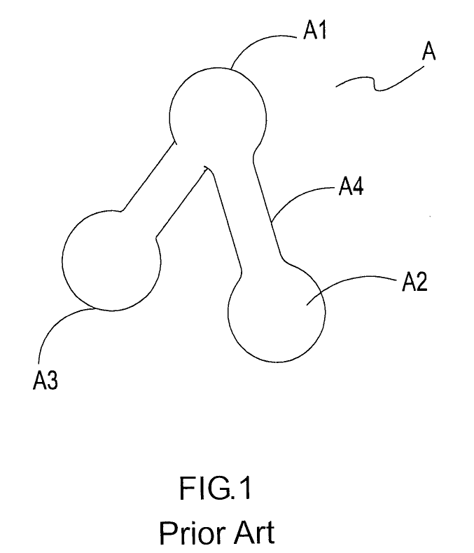

FIG. 2 shows an elevational view according to the invention.

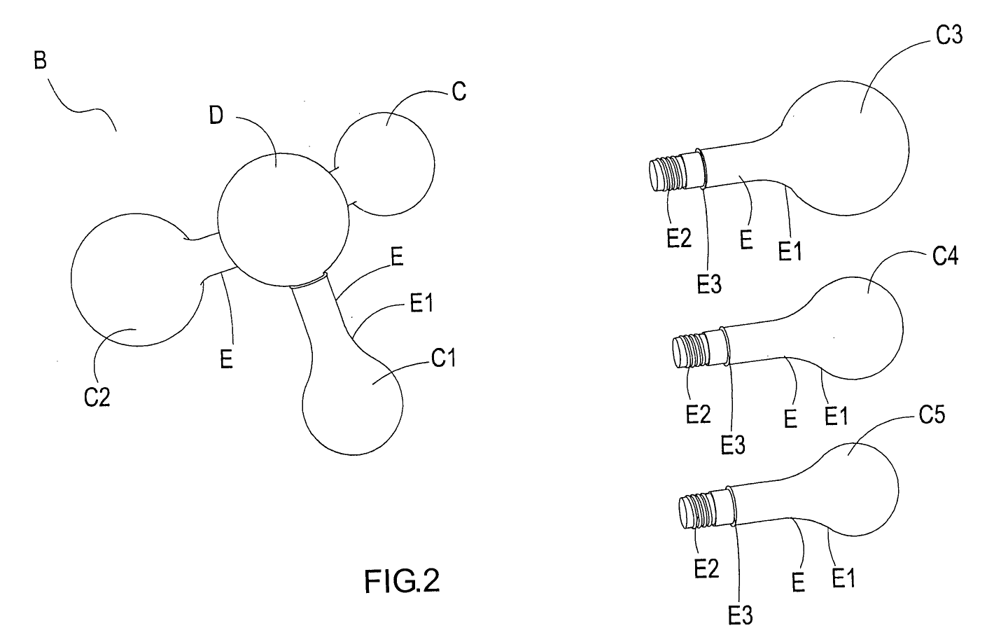

FIG. 3 shows an exploded elevational view according to the invention.

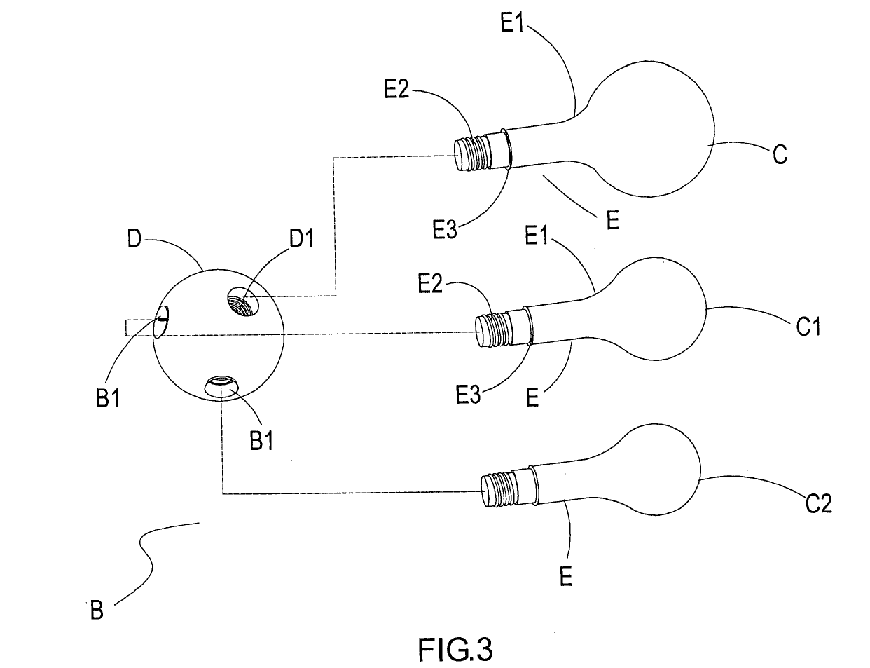

FIG. 4 shows a partial elevational view according to the invention.

FIG. 5 shows an implementation diagram according to the invention.

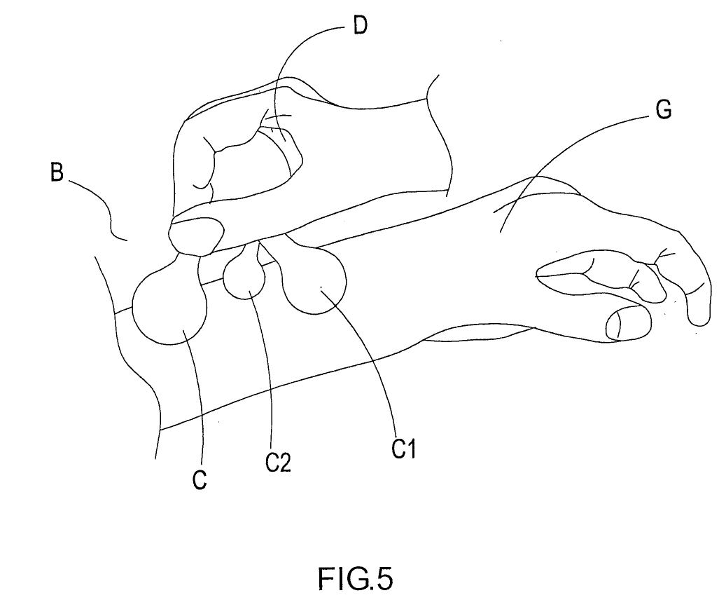

FIG. 6 shows another implementation diagram according to the invention.

FIG. 7 shows a first application diagram showing an implementation according to the invention.

FIG. 8 shows a second application diagram showing an implementation according to the invention.

FIG. 9 shows a third application diagram showing an implementation according to the invention.

### DETAILED DESCRIPTION OF THE PREFERRED EMBODIMENTS

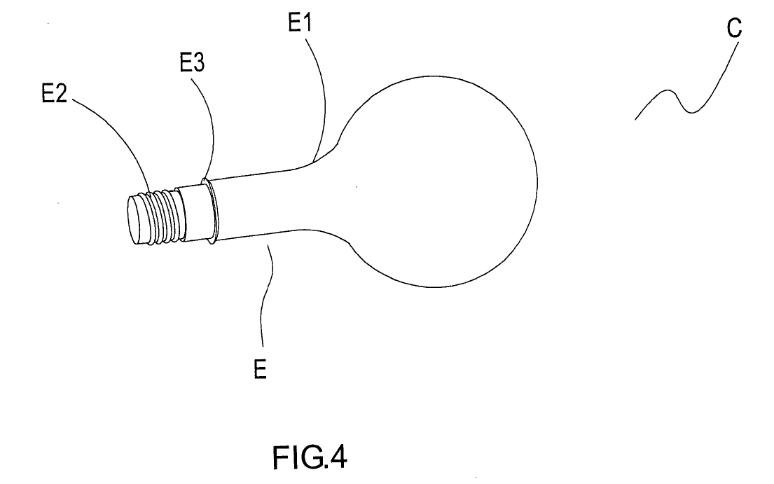

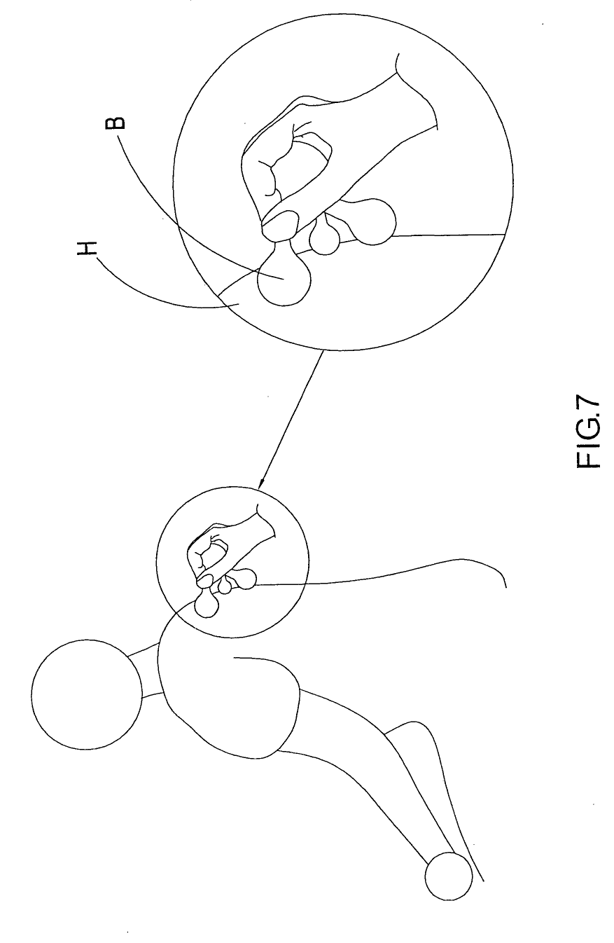

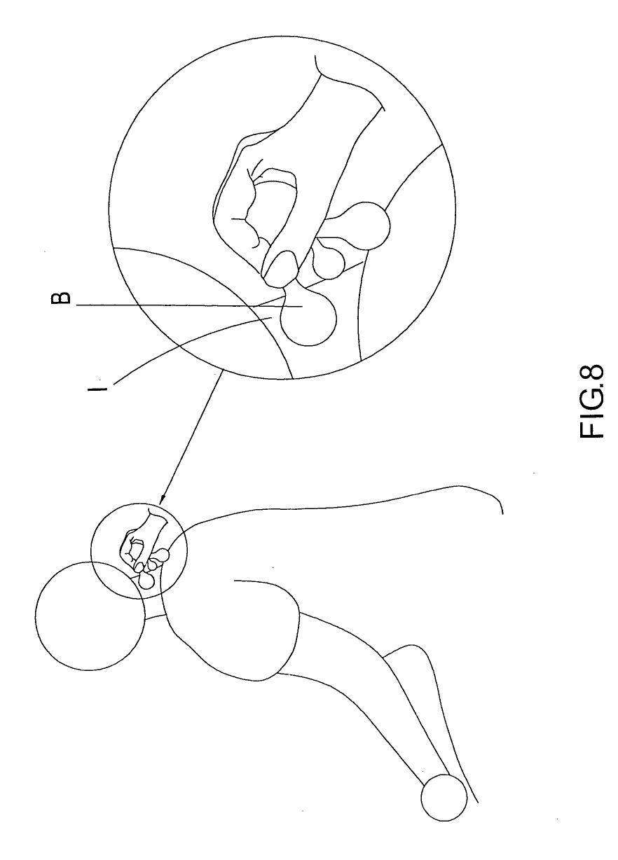

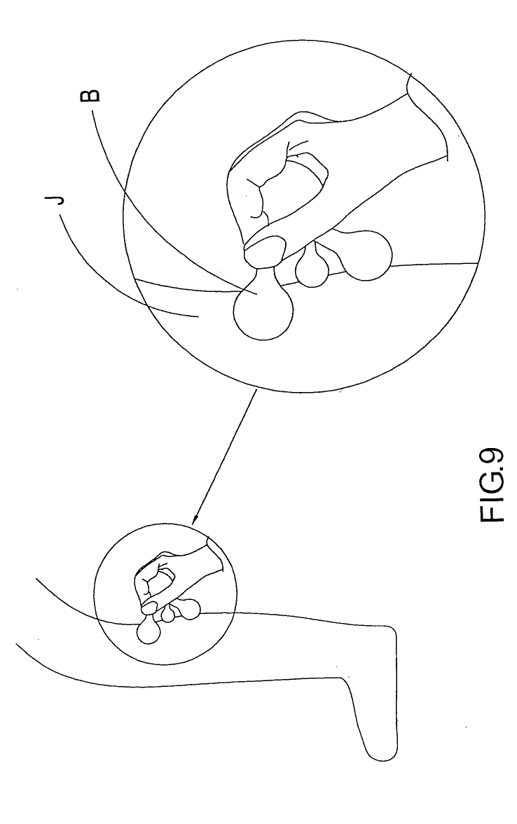

Referring to FIGS. 4, 7, 8 and 9 showing the tri-point replaceable handheld massage device being utilized, a user holds the main body D functioning in conjunction with a three-dimensional structure composed by the massage sections C, C1 and C2, and massages various portions such as a hand G, a back H, a neck I and a leg J of a body. Also, the massage sections are ergonomic designs that are suitable for various portions of a body as well as being favorable for force application of a user. When applying the invention, a user is able to replace the massage sections C having different sizes based on usage needs.

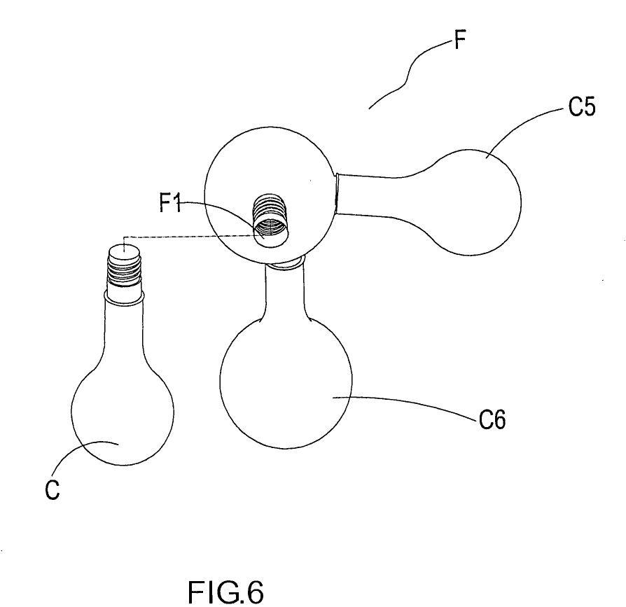

Referring to FIG. 6, a main body F is further devised as having only one screw opening F1 for providing only one replaceable massage section C, so as to facilitate a user who does not frequently replace the massage section C and only uses the massage device to massage specific portions of a body, and to further provide conveniences when put to use.

To make the novelty and practicability of the invention more distinguishing, the present invention is compared with the prior invention as below:

Drawbacks of the prior invention:
1. The massage sections have invariable and irreplaceable sizes.
2. The neck portion is prone to breakage due to excessive force applied by a user.
3. Designs are non-ergonomic and thus difficult to handle by a user.
   Excellences of the present invention:
1. The replaceable massage sections have various sizes according to usage needs.
2. The tri-point designs favor a user to easily grasp while also conforming to ergonomic considerations.
3. The structures of neck sections are reinforced by the dilated sections for preventing breakage during usage.
4. The massage device has a small volume and can be disassembled for offering storage and portability conveniences.
5. The invention provides novelty and practicability.
6. The invention enhances industrial competitiveness.

It is of course to be understood that the embodiment described herein is merely illustrative of the principles of the invention and that a wide variety of modifications thereto may be effected by persons skilled in the art without departing from the spirit and scope of the invention as set forth in the following claims.

1-6. (canceled)

7. A handheld massage device comprising:
a) a circular main body having at least one threaded opening; and
b) a plurality of message bodies, each of the plurality of message bodies having a message section and a neck section connected to the message section, each neck section having:
i) a threaded section located on a first end; and
ii) a dilated section flaring outwardly from a second end thereof and connected to the message section,
wherein one of the plurality of message bodies being removably connected to each of the at least one threaded opening.

8. The handheld massage device according to claim 7, wherein the at least one threaded opening includes three openings, and the plurality of message bodies includes at least three message bodies.

9. The handheld massage device according to claim 7, wherein the neck section of each of the plurality of message bodies has a projecting section located adjacent to the threaded section and engaging an exterior of the circular main body.

10. The handheld massage device according to claim 7, wherein the neck section and the massage section are integrally made.
